(19) United States
(12) Patent Application Publication
(10) Pub. No.: US 2016/0217817 A1
(43) Pub. Date: Jul. 28, 2016

(54) MAGNETIC POWDER FOR MAGNETIC RECORDING MEDIUM

(71) Applicants: DOWA ELECTRONICS MATERIALS CO., LTD., Tokyo (JP); FUJIFILM Corporation, Tokyo (JP)

(72) Inventors: Kenji MASADA, Tokyo (JP); Hirohisa OMOTO, Tokyo (JP); Futoshi NAGASHIMA, Tokyo (JP); Hiroyuki SUZUKI, Kanagawa (JP); Toshio TADA, Kanagawa (JP)

(21) Appl. No.: 15/002,599

(22) Filed: Jan. 21, 2016

(30) Foreign Application Priority Data
Jan. 22, 2015 (JP) 2015-010108

(51) Int. Cl. G11B 5/72

(52) U.S. Cl. CPC G11B 5/72

(57) ABSTRACT

A hexagonal ferrite magnetic powder for a magnetic recording medium, containing magnetic powder contains hexagonal ferrite particles having coated on the surface thereof an aluminum hydroxide material, having a Ba/Fe molar ratio of 0.080 or more, a Bi/Fe molar ratio of 0.025 or more, and an Al/Fe molar ratio of from 0.030 to 0.200. The magnetic powder preferably has an activation volume Vact of from 1,300 to 2,000 nm³. The magnetic powder particularly preferably has a coercive force Hc of from 159 to 287 kA/m (approximately from 2,000 to 3,600 Oe) and a coercivity distribution SFD of from 0.3 to 1.0. The magnetic powder may contain one or two or more kinds of a divalent transition metal M1 and a tetravalent transition metal M2, as an element that replaces Fe of the hexagonal ferrite. The magnetic powder has improved magnetic characteristics including SNR and durability.

### TECHNICAL FIELD

The present invention relates to M-type hexagonal ferrite magnetic powder for a magnetic recording medium.

### BACKGROUND ART

Hexagonal ferrite magnetic powder has been known as magnetic powder suitable for high density recording used in a magnetic recording medium. For example, PTL 1 describes hexagonal ferrite magnetic powder that has a small particle size and improved magnetic characteristics achieved by adding a rare earth element and Bi thereto.

On the other hand, a magnetic recording medium, such as a magnetic tape, is demanded to have excellent durability on running on a drive, in addition to good magnetic characteristics as a medium. PTL 2 describes a technique of improving the durability of a magnetic recording medium by using hexagonal ferrite magnetic powder having a surface coated with Al. PTL 3 describes that Al₂O₃ is coated on a surface of magnetic powder. As a measure therefor, the literature describes an example, in which aluminum hydroxide is deposited on the surface of magnetic powder, and the magnetic powder is rinsed with water and then dried by heating to 150° C. for 48 hours, so as to provide magnetic powder having Al₂O₃ coated on the surface thereof (paragraph 0036). PTLs 4 and 5 describe a technique of improving the dispersibility of hexagonal ferrite particles in a resin by coating aluminum hydroxide on the surface thereof.

### CITATION LIST

### Patent Literatures

[PTL 1] JP-A-2011-178654

[PTL 2] JP-A-2011-225417

[PTL 3] JP-A-9-213513

[PTL 4] JP-A-64-61324

[PTL 5] JP-A-4-141820

### SUMMARY OF INVENTION

### Technical Problem

In a recent trend of increasing utilization of digital data, a magnetic recording medium, which is to store a huge amount of data, is required to be further improved hereafter in both the magnetic characteristics and the durability. For the improvement, it has been considered to be effective, for example, to combine the magnetic characteristics improving technique with the hexagonal ferrite magnetic powder having Bi added thereto described in PTL 1 and the durability improving technique with the hexagonal ferrite magnetic powder having Al added thereto described in PTL 2.

As a result of investigation by the present inventors, however, it has been found that only the utilization of the measure of PTL 1 and the measure of PTL 2 fails to provide sufficient improvement in SNR (S/N ratio), which is one of the important factors of the magnetic characteristics of the medium. In recent years, the demand on the SNR of the magnetic recording medium is becoming severe, corresponding to the increasing recording density.

While the durability of the magnetic recording medium has been improved with the hexagonal ferrite magnetic powder having Al added thereto described in PTL 2, further improvement is being demanded recently. It has been found that the durability cannot be sufficiently improved even by using the technique of coating Al₂O₃ described in PTL 3. PTLs 4 and 5 teach that the dispersibility of the magnetic particles in a resin is improved by coating with aluminum hydroxide. However, in a magnetic coated layer constituting the magnetic recording medium, the organic material (base material) has a smaller strength than the magnetic particles dispersed in the coated film, and thus breakage of the coated film is liable to occur in the portion of the organic material. Assuming that the amounts of the magnetic particles and the organic material used are the same, the better dispersibility makes the aggregates of the magnetic particles finely dispersed in the organic material, and thus the thickness of the organic material bonding the magnetic particles becomes relatively thin, which promotes breakage of the coated film. Furthermore, the bonding surface area of the magnetic particles and the organic material is increased, and thus the probability of breakage of the coated film is increased. It has been found from the past investigations that the magnetic recording medium in this state is deteriorated in durability. Accordingly, there is a trade-off relationship between the durability of the magnetic recording medium and the dispersibility of the magnetic particles, and it has been ordinarily considered that the measure that is advantageous for improving the dispersibility is difficult to be applied to the case where the durability is to be improved.

The invention is to provide magnetic powder that is capable of achieving simultaneously both improvement of the magnetic characteristics including the SNR and further improvement of the durability of a magnetic recording medium.

### Solution to Problem

As a result of detailed investigations, the inventors have found that it is considerably effective for improving the SNR of a magnetic recording medium in M-type hexagonal ferrite powder improved in magnetic characteristics by adding Bi thereto, the content of Ba present in the powder is sufficiently assured. It is considered that the effective industrial production method of M-type hexagonal ferrite powder containing Bi employed is such a method that a molten material of a raw material mixture is quenched to form an amorphous material, which is then crystallized by heating to a prescribed temperature, so as to synthesize hexagonal ferrite, and the method is used in PTLs 1 and 2. In the case where the method is used, in general, it is necessary to perform a treatment of removing residual substances formed mainly of barium borate by dissolving with an acid (acid cleaning), as a post process step. Ba in the basic structure of BaO.6Fe₂O₃ is one of the major components of M-type hexagonal ferrite, and Ba constituting the ferrite may be eluted in the acid cleaning, resulting in some cases where the actual Ba content is smaller than the amount that is assumed from the raw material composition. It is important to prevent the shortage of Ba. Specifically, it has been found that the Ba content that stably makes a Ba/Fe molar ratio of 0.080 or more is considerably effective for improving the SNR.

In PTL 2, Al is added to the raw material before baking. In this case, Al is converted to aluminum oxide (Al₂O₃) in the step of forming a glassy material, and in the process of depositing Ba ferrite by cooling the glassy material, such a state is provided that the surface of the ferrite deposited particles is coated with aluminum oxide. The inventors have found that the durability of a magnetic recording medium can be significantly improved in such a manner that instead of Al₂O₃ an aluminum hydroxide material, which is constituted by aluminum hydroxide, bayerite, boehmite, an amorphous aluminum hydroxide gel, and the like, is coated directly on the surface of the Bi-added Ba ferrite particles by a surface treatment.

The invention has been completed based on the knowledge.

The purpose of the invention is achieved by hexagonal ferrite magnetic powder for a magnetic recording medium, containing magnetic powder containing hexagonal ferrite particles having coated on the surface thereof an aluminum hydroxide material, having a Ba/Fe molar ratio of 0.080 or more, a Bi/Fe molar ratio of 0.025 or more, and an Al/Fe molar ratio of from 0.030 to 0.200. The magnetic powder preferably has an activation volume Vact of from 1,300 to 2,000 nm³. The magnetic powder optimally has a coercive force Hc of from 159 to 287 kA/m (approximately from 2,000 to 3,600 Oe) and a coercivity distribution SFD of from 0.3 to 1.0. The magnetic powder may contain one kind or two or more kinds of an element selected from a divalent transition metal and a tetravalent transition metal, as an element that replaces a part of Fe sites of the hexagonal ferrite. In the description herein, the divalent transition metal that replaces a part of Fe sites is represented by M1, and the tetravalent transition metal is represented by M2. Examples of M1 include Co, Zn and the like, and examples of M2 include Ti, Sn and the like. The M1/Fe molar ratio is preferably in a range of from 0 to 0.060, and the M2/Fe molar ratio is preferably in a range of from 0 to 0.060.

The Ba/Fe molar ratio, the Bi/Fe molar ratio, and the Al/Fe molar ratio are values that are determined by the following expressions based on the analytical values of the powder.

Ba/Fe molar ratio=(Ba content (mol))/(Fe content (mol))

Bi/Fe molar ratio=(Bi content (mol))/(Fe content (mol))

Al/Fe molar ratio=(Al content (mol))/(Fe content (mol))

The M1/Fe molar ratio and the M2/Fe molar ratio are values that are determined by the following expressions based on the analytical values of the powder.

M1/Fe molar ratio=(M1 content (mol))/(Fe content (mol))

M2/Fe molar ratio=(M2 content (mol))/(Fe content (mol))

In the case where plural elements (for example, Co and Zn) are used as M1, the M1 content employed is the total molar number of the M1 elements. Similarly, in the case where plural elements (for example, Ti and Sn) are used as M2, the M2 content employed is the total molar number of the M2 elements.

The hexagonal ferrite magnetic powder may be obtained in such a method that in an aqueous solution (slurry) containing hexagonal Ba ferrite powder particles containing Bi, an aluminum hydroxide material is deposited on the surface of the particles, and then the particles in the slurry is rinsed with water and then dried at a low temperature of 120° C. or less.

Specifically, a method for producing hexagonal ferrite magnetic powder for a magnetic recording medium is provided, containing: a step of depositing an aluminum hydroxide material to a surface of hexagonal ferrite particles in an aqueous medium; a step of rinsing the hexagonal ferrite particles having the aluminum hydroxide material deposited thereto, with water; and a step of drying the hexagonal ferrite particles after being rinsed with water, at a temperature of 120° C. or less. The hexagonal ferrite particles that is applied to the step of depositing an aluminum hydroxide material may be a Bi-containing hexagonal Ba ferrite particles controlled to have a Ba/Fe molar ratio of 0.080 or more and a Bi/Fe molar ratio of 0.025 or more.

The step of depositing an aluminum hydroxide material is preferably such a procedure that an alkali is added to an aluminum salt aqueous solution having the hexagonal ferrite particles dispersed therein having pH of from 2.0 to 5.0, so as to control the pH to from 7.0 to 10.0. A magnetic recording medium having a magnetic layer containing the hexagonal ferrite magnetic powder is also provided. The pH may be measured with a glass electrode according to JIS Z8802:2011.

### Advantageous Effects of Invention

The magnetic powder for a magnetic recording medium according to the invention improves the magnetic characteristics of a magnetic recording medium, particularly both the SNR and the durability simultaneously, to high levels.

### DESCRIPTION OF EMBODIMENTS

### Hexagonal Ferrite Magnetic Powder

### Component Composition

The hexagonal ferrite used in the invention is a magnetoplumbite type (M-type) having a basic structure of BaO.6Fe₂O₃. Apart of the Fe sites thereof may be replaced by one or more kinds of a divalent transition metal M1 and a tetravalent transition metal M2. Examples of the divalent transition metal M1 include Co, Zn and the like, and examples of the tetravalent transition metal M2 include Ti, Sn and the like. The replacement of the transition metal may control the magnetic characteristics, such as the coercive force Hc. The M1/Fe molar ratio is preferably in a range of from 0 to 0.060, and more preferably in a range of from 0 to 0.040. The M2/Fe molar ratio is preferably in a range of from 0 to 0.060, more preferably from 0.001 to 0.060, and further preferably from 0.005 to 0.060.

Ba is one of the major components constituting the hexagonal ferrite, and when Ba is eluted in the step of rinsing with an acid, and the like, it is expected that a part of Ba sites of the resulting magnetic powder may be vacant. The magnetic powder in this state may fail to exhibit sufficiently the magnetic characteristics that are to be obtained by the inherent crystalline structure. In particular, magnetic powder having a reduced particle size has a large specific surface area, and thus the deterioration of the magnetic characteristics due to the influence of the loss of Ba is liable to be increased. Accordingly, the improvement of the SNR due to the reduction of the particle size may be balanced out therewith, and it is the current situation that the SNR satisfying the higher demand level than the ordinary products may not be stably achieved.

In the case where the hexagonal ferrite is synthesized by the method of crystallizing an amorphous material of the raw material mixture, the raw material mixture contains a large amount of Ba and B as a component that is necessary for providing the amorphous material. Specifically, Ba is a constitutional component of the hexagonal ferrite and is simultaneously a component for providing the amorphous material. In the process of crystallization, Ba is distributed to the hexagonal ferrite and the other crystalline substances. As a result of investigations made by the inventors, it has been found that the amount of Ba that is distributed to the constitutional component of the hexagonal ferrite can be controlled to a certainly high level estimating the loss in the subsequent process, by controlling the composition of the raw material mixture.

In the invention, the magnetic powder has a Ba/Fe molar ratio of 0.080 or more. According thereto, the SNR of the magnetic recording medium can be stably retained to a high level. It has been found that the SNR tends to be deteriorated when the Ba/Fe molar ratio is lower than 0.080. In the BaO.6Fe₂O₃ structure, the stoichiometric Ba/Fe molar ratio is approximately 0.083. Even when Ba is eluted by an acid cleaning process or the like to make a part of the Ba sites vacant, the adverse affect thereof to the magnetic characteristics may not be manifested as far as the amount of the vacant sites is small, but it is considered that the magnetic characteristics may be drastically deteriorated when the amount of the vacant sites is increased to a certain level. In the hexagonal ferrite magnetic powder as an object of the invention, it is considered that when the Ba/Fe molar ratio is 0.080 or more, the inherent magnetic characteristics are not largely deteriorated, and as a result, the SNR of the magnetic recording medium is maintained to a high level.

The upper limit of the Ba/Fe molar ratio may not be necessarily determined since crystals having Ba in an amount that largely exceeds the stoichiometric amount are not essentially synthesized even through the Ba content in the raw material mixture is excessive. In general, the Ba/Fe molar ratio may be in a range of 0.010 or less.

The total Fe amount of the hexagonal ferrite magnetic powder as an object of the invention is 25% by mol or more.

The hexagonal ferrite magnetic powder of the invention contains Bi and Al.

Bi is an element that is effective for reducing the particle size and for improving the magnetic characteristics. The most part of Bi in the raw material mixture enters the hexagonal ferrite magnetic powder. As a result of various investigations, for providing the effects of Bi sufficiently, it is effective to control the amount of Bi added in the raw material mixture to make a Bi/Fe molar ratio of the magnetic powder of 0.025 or more. It is more effective to make a Bi/Fe molar ratio of 0.030 or more. However, in the case where Bi, which is a non-magnetic component, is contained in a large amount in the magnetic powder, there may be cases where deterioration of the magnetic characteristics caused thereby may be a problem, depending on the purpose. The Bi/Fe molar ratio is preferably in a range of 0.100 or less, and more preferably 0.060 or less.

In the invention, Al is an element that is necessary for depositing an aluminum hydroxide material to the surface of the hexagonal ferrite particles by a surface treatment. Accordingly, it is not necessary to add Al to the raw material for synthesizing the hexagonal ferrite. As a result of investigations made by the inventors, it has been found that a coated layer formed by coating an aluminum hydroxide material, which is constituted by one kind or two or more kinds of aluminum hydroxide, bayerite, boehmite, and an amorphous aluminum hydroxide gel, on the surface of the Hi-containing hexagonal Ba ferrite magnetic particles is considerably effective for improving the durability of the magnetic layer of the magnetic recording medium (such as a magnetic tape). The mechanism thereof is still unclear under the current situation, but as a result of detailed investigations, the effect of improving the durability is exhibited by depositing the aluminum hydroxide material to make an Al/Fe molar ratio in the magnetic powder 0.030 or more. The Al/Fe molar ratio is more effectively 0.040 or more, and further effectively 0.010 or more. However, Al, which is a non-magnetic component, is contained in an excessive amount, it may be a factor deteriorating the magnetic characteristics. Accordingly, the Al/Fe molar ratio is preferably in a range of 0.200 or less, and may be managed to 0.150 or less. PTLs 4 and 5 described previously do not describe any problem relating to the durability of the magnetic recording medium. It is thus not expected from PTLs 4 and 5 teaching the improvement of the dispersibility that the durability of the magnetic recording medium is considerably improved by depositing the aluminum hydroxide material to the hexagonal Ba ferrite particles containing Bi.

A rare earth element may be added as an additional component to the raw material. A rare earth element contributes to reduce the particle size of the hexagonal ferrite. While the rare earth element is represented by R, it is effective to add one or more kind of a rare earth element to the raw material mixture in an amount that provides an R/Fe molar ratio in the analysis of the magnetic powder in a range of from 0.001 to 0.010. In the description herein, Sc and Y are also included in the rare earth element. For example, Nd, Sm, Y, Er, Ho and the like are preferably used, and among these, Nd, Sm, and Y are preferred.

### Activation Volume Vact

The activation volume Vact calculated from the measurement of the magnetic characteristics of the powder is desirably from 1,300 to 2,000 nm³. In the case where the magnetic powder is used in a magnetic recording medium, a larger packing density of the magnetic powder is effective for improving the SNR (i.e., reducing noise). In this point of view, the use of magnetic powder having small Vact is advantageous. However, for reducing the Vact extremely, it is necessary to make the particle size of the powder extremely small, which is associated with difficulty in production. Furthermore, in an M-type hexagonal ferrite having Ba as the alkaline earth metal element site, the loss of Ba in the acid cleaning process may be increased with the smaller particle size. The loss of Ba may cause deterioration of the magnetic characteristics, and may be a factor that balances out the effect of improving the SNR by reducing the particle size (i.e., reducing the Vact). On the other hand, a larger Vact is advantageous for suppressing the Ba loss, but the effect of improving the SNR of the magnetic recording medium may be reduced due to the large particle size, and the recent severe demand in the SNR characteristics may not be satisfied. As a result of various investigations on these factors, it has been found that in the case where the improvement of the SNR is particularly important in the hexagonal ferrite magnetic powder containing Ba as a major component, the activation volume Vact is preferably from 1,300 to 2,000 nm³.

The durability of the magnetic recording medium is largely improved in such a manner that the existence form of the Al component deposited to the surface of the hexagonal ferrite particles is the aluminum hydroxide material, instead of aluminum oxide, as described above. However, it has been understood that when the size of the magnetic particles to be dispersed in the magnetic layer of the magnetic recording medium is small, the effect of improving the durability due to the deposition of the aluminum hydroxide material tends to be small. The mechanism thereof is still unclear under the current situation, but it is considered that when the size of the magnetic powder dispersed in the magnetic layer become smaller, the specific surface area thereof is increased to increase the area of the interface to the resin material constituting the magnetic layer, and thereby the possibility of detachment between the magnetic particles and the resin base material is increased. As a result of various investigations, in the case of a magnetic recording medium using Bi-containing Ba ferrite, it is advantageous to control the activation volume Vact to a range of 1,300 nm³ or more from the standpoint of the durability.

In the case where the hexagonal ferrite is synthesized by the method of crystallizing an amorphous material of the raw material mixture, the activation volume Vact of the resulting hexagonal ferrite powder can be controlled by the combination of the component composition of the amorphous material and the crystallization condition (particularly, the heating temperature).

### Magnetic Characteristics

The magnetic powder as an object of the invention preferably has a coercive force Hc of from 159 to 287 kA/m (approximately from 2,000 to 3,600 Oe) and a coercivity distribution SFD of from 0.3 to 1.0. The magnetic powder preferably has a saturation magnetization us of from 40.0 to 45.0 A·m²/kg and a squareness ratio SQR of from 0.48 to 0.56. The magnetic powder that has these characteristics is useful as a material for high-density recording.

### Specific Surface Area Sbet

The reduction of the particle size of the magnetic powder used is effective for reducing the noise of the magnetic recording medium, as described above. On viewing the size factor of the particles from the specific surface area, the specific surface area Sbet by the BET one-point method is preferably from 50 to 110 m²/g.

### Production Method of Magnetic Powder

The hexagonal ferrite magnetic powder according to the invention can be produced by a method of crystallizing an amorphous material of a raw material mixture. Specifically, the magnetic powder can be produced through the following procedures.

### Raw Material Mixing Step

Raw material substances containing elements that constitute the hexagonal ferrite magnetic powder and elements that are required for forming the amorphous material are mixed to provide raw material mixed powder. The hexagonal ferrite magnetic powder according to the invention has BaO.6Fe₂O₃ as the basic structure, in which a part of Fe is replaced with one or more kind of a divalent or tetravalent transition metal depending on necessity, Bi is contained as an additional element, and a rare earth element is contained depending on necessity. As elements for providing the amorphous material, Ba and B are preferably contained in large amounts. Among these elements, the source of the metal element used is generally an oxide or a hydroxide of the element. The sources of Ba and B used are preferably BaCO₃ and H₃BO₃, respectively.

Ba is a constitutional element of the hexagonal ferrite, and is simultaneously an element for forming the amorphous material. The hexagonal ferrite magnetic powder according to the invention has a feature that a high Ba/Fe molar ratio is maintained, as described above. In the raw material mixing step, the formulation of the raw materials is determined for distributing a sufficient amount of Ba to the hexagonal ferrite in the crystallization step in consideration of the balance to the element required for amorphization.

The raw material substances are mixed and agitated in a mixer to form a raw material mixture. The raw material substances are preferably subjected to shear mixing with a mixer having agitation blades, such as a Henschel mixer.

### Granulation Step

It is the general procedure that the resulting raw material mixture is formed into a spherical granulated product having a prescribed particle diameter, taking the handleability in the subsequent steps, and the like into consideration. For example, the raw material mixture is formed into a spherical shape using a pan-type granulating machine while adding water or depending on necessity a binder component, so as to produce a particulate product having a diameter of approximately from 1 to 50 mm, which is then dried by heating to a temperature of approximately from 200 to 300° C. to provide a granulated product.

### Amorphization Step

The dried raw material mixture (i.e., the granulated product) is melted by heating to a high temperature, so as to provide a molten material at a temperature of from 1,350 to 1,450° C. The molten material is then quenched to provide an amorphous material. Examples of the method of quenching include a twin-roll method, a gas atomization method, a water atomization method, and a centrifuge atomization method. According to the investigation made by the inventors, it is more effective for providing the amorphous material by a gas atomization method in the case where the hexagonal ferrite crystals having a sufficient Ba content, an activation volume Vact within the aforementioned range, and a reduced particle size are to be formed from the amorphous material containing Bi. The resulting amorphous material may be pulverized with a ball mill or the like and then regulated in particle size, depending on necessity.

### Crystallization Step

The amorphous material is heated and retained in a temperature range of from 600 to 720° C., so as to deposit hexagonal ferrite crystals. The retention time may be generally from 60 to 240 minutes. The powder obtained through the heat treatment for crystallization contains the hexagonal ferrite crystals, and in addition, substances formed through crystallization of the remaining components contained in the amorphous material (which are mainly barium borate crystals).

### Acid Cleaning Step

For extracting the hexagonal ferrite particles from the powder obtained through the crystallization step, the remaining substances formed mainly of barium borate are removed by dissolving with an acid. This treatment is referred to as acid cleaning. The acid cleaning liquid is preferably an acetic acid aqueous solution having a concentration of from 2 to 12% by mass. The powder obtained through the crystallization step is immersed in the acid cleaning liquid and retained to a temperature equal to or lower than the boiling point. It is effective to agitate the liquid. A pH of the liquid is preferably of 4.0 or less. After completing the dissolution of the remaining components, the hexagonal ferrite powder is extracted by solid-liquid separation.

In the acid cleaning, a part of Ba constituting the hexagonal ferrite is dissolved, as described above. That is, Ba loss occurs. In the case where the Ba content is smaller than the stoichiometric Ba content of the M-type hexagonal ferrite, it is considered that the Ba sites are partially vacant. It is considered that the magnetic characteristics are drastically deteriorated when the amount of the vacant sites is increased to a certain level. In particular, the M-type hexagonal ferrite having a reduced particle size with Vact of 2,000 nm³ is liable to suffer the Ba loss by the acid cleaning. From the standpoint of assuring the Ba content for maintaining a high SNR as the medium characteristics, the invention targets the hexagonal ferrite magnetic powder that has a Ba/Fe molar ratio of 0.080 or more. According to the detailed experimentation by the inventors, it has been confirmed that the hexagonal ferrite magnetic powder that has a Ba/Fe molar ratio of 0.080 can be consequently obtained even though the Ba loss occurs in the acid cleaning, by controlling the composition of the raw material mixture and the conditions in crystallization (crystallization temperature).

The hexagonal ferrite powder thus extracted through solid-liquid separation has the acid cleaning liquid attached thereto, and thus the acid cleaning liquid is washed out. The treatment is referred to as water rinsing. As an initial stage of the water rinsing, a neutralization treatment with an alkali aqueous solution, such as ammonia water, a sodium hydroxide aqueous solution, and a potassium hydroxide aqueous solution, may be performed. The concentration of the alkali aqueous solution may be controlled, for example, within a range of from 0.01 to 1.5 mol/L for sodium hydroxide.

### Pulverization Step

The hexagonal Ba ferrite thus obtained is preferably formed into fine powder by performing a pulverization treatment. Specifically, the hexagonal Ba ferrite is preferably refined sufficiently before the aluminum hydroxide material depositing step, so that 90% or more of the particles have a particle diameter in a range of from 0.1 to 100 μM in the particle size distribution on a volume basis according to a laser diffraction/scattering method.

### Aluminum Hydroxide Material Depositing Step

The hexagonal Ba ferrite particles after the wet pulverization are dispersed in an aqueous solution having an aluminum salt dissolved therein, so as to form a slurry. An alkali is then added to the slurry to perform formation reaction of the aluminum hydroxide material, thereby forming a layer of the aluminum hydroxide material on the surface of the hexagonal Ba ferrite particles. The temperature of the slurry may be approximately from 25 to 50° C. A pH of the liquid before the reaction (before the addition of an alkali) preferably is of from 2.0 to 5.0, and more preferably in a range of from 2.0 to 4.0. When the pH before the reaction is lower than 2.0, a part of the hexagonal Ba ferrite particles is liable to be dissolved, which may be a factor of deteriorating the magnetic characteristics in some cases. A pH of the liquid in the reaction preferably is controlled to from 7.0 to 10.0. In the case where the pH is lower than 7.0 or higher than 10.0, it may be difficult to form sufficiently the aluminum hydroxide material effective for improving the durability of the magnetic recording medium, and to deposit the material to the surface of the hexagonal ferrite particles. After completing the reaction, the slurry is preferably agitated at the temperature within the aforementioned range for approximately from 5 to 30 minutes. Examples of the aluminum salt capable of being applied include aluminum chloride, aluminum nitrate, aluminum sulfate, aluminum phosphate, aluminum citrate, and aluminum acetate. Examples of the alkali capable of being applied include sodium hydroxide, potassium hydroxide, and ammonia. The amount of the aluminum salt used is preferably such an amount that the amount of Al is from 2 to 17 parts by mass in terms of Al(OH)₃ per 100 parts by mass of the solid content (i.e., the hexagonal Ba ferrite particles after the wet pulverization).

The slurry containing the hexagonal Ba ferrite particles having the aluminum hydroxide material deposited to the surface thereof is subjected to solid-liquid separation by such a measure as filtration to recover the solid content. The solid content is then sufficiently rinsed with water. Specifically, the solid content is preferably rinsed with water sufficiently to make a conductivity of the liquid after rinsing (filtrate) 10 μS/cm or less.

The solid content after the water rinsing is then dried at a temperature of 120° C. or less, and more preferably 115° C. or less. The drying time may be selected from a range of from 1 to 20 hours. When the drying temperature is high exceeding 120° C., it may be difficult to improve significantly and stably the durability of the magnetic recording medium. The lower limit of the drying temperature may not be particularly identified, and may be ordinary temperature. For example, the drying temperature may be set in a range of from 20 to 120° C. According to the procedures, the powder is obtained which is formed of the magnetic particles containing the Bi-containing hexagonal Ba ferrite particles having the aluminum hydroxide material deposited to the surface thereof.

### Magnetic Recording Medium

The hexagonal ferrite magnetic powder according to the invention may be applied to a magnetic layer of a magnetic recording medium. A magnetic recording medium, to which the hexagonal ferrite magnetic powder according to the invention is preferably applied, will be described, for example, as a magnetic tape. The magnetic tape is constituted from the upper surface, assuming that the surface thereof in contact with a magnetic head is designated as the upper surface, by a magnetic layer, a non-magnetic layer, and a non-magnetic support, and may have a back coating layer thereunder in some cases.

### Magnetic Layer

The magnetic layer contains the hexagonal ferrite magnetic powder described above, and a binder.

Examples of the binder used include a polyurethane resin, a polyester resin, a polyamide resin, a vinyl chloride resin, an acrylic resin obtained by copolymerizing styrene, acrylonitrile, methyl methacrylate and the like, a cellulose resin, such as nitrocellulose, an epoxy resin, a phenoxy resin, and a polyvinyl alkylal resin, such as polyvinyl acetal and polyvinyl butyral, which may be used solely or as a mixture of two or more kinds thereof. Among these, a polyurethane resin, an acrylic resin, a cellulose resin, and a vinyl chloride resin are particularly preferred. The resins may also be used as a binder for a non-magnetic layer described later. The binder preferably has a functional group (polar group) that is adsorbed on the magnetic powder for improving the dispersibility of the powder. Examples of the functional group include —SO₃M, —SO₄M, —PO(OM)₂, —OPO(OM)₂, —COOM, ═NSO₃M, ═NRSO₃M, —NR¹R², and —N⁺R¹R²R³X⁻, wherein M represents hydrogen or an alkali metal, such as Na and K, R represents an alkylene group, R¹, R², and R³ each represent an alkyl group, a hydroxyalkyl group, or hydrogen, and X represents halogen, such as Cl and Br. The amount of the functional group in the binder is preferably 10 μeq/g or more and 200 μeq/g or less, and more preferably 30 μeq/g or more and 200 μeq/g or less, for providing good dispersibility.

The molecular weight of the binder is preferably 10,000 or more and 200,000 or less in terms of mass average molecular weight. The molecular weight that is in the range is preferred since the coated film may have a sufficient strength, good durability may be obtained, and the dispersibility may be improved.

The amount of the binder may be controlled, for example, within a range of from 5 to 50% by mass, and preferably from 10 to 30% by mass, with respect to the magnetic powder. A polyisocyanate curing agent may be used along with the resin.

The magnetic layer may contain an additive depending on necessity. Examples of the additive include an abrasive, a lubricant, a dispersant and a dispersing assistant, a fungicide, an antistatic agent, an antioxidant, a solvent, and carbon black, which may be appropriately selected from commercially available products and products obtained by known methods, and may be used in amounts corresponding to the intended properties. Examples of the carbon black capable of being used in the magnetic layer include furnace black for rubber, thermal black for rubber, carbon black for colorant, and acetylene black. Examples of a fatty acid and a derivative thereof that are widely used as the lubricant include capric acid, caprylic acid, lauric acid, myristic acid, palmitic acid, stearic acid, behenic acid, oleic acid, elaidic acid, linoleic acid, linolenic acid, and isostearic acid. Examples of an ester compound therefor include butyl stearate, octyl stearate, amyl stearate, isooctyl stearate, butyl myristate, octyl myristate, butoxyethyl stearate, butoxydiethyl stearate, 2-ethylhexyl stearate, 2-octyldodecyl palmitate, 2-hexyldodecyl palmitate, isohexadecyl stearate, oleyl oleate, dodecyl stearate, tridecyl stearate, oleyl erucate, neopentyl glycol didecanoate, and ethylene glycol dioleate. The content of the fatty acid and the derivative thereof may be, for example, from 0.1 to 20 parts by mass per 100 parts by mass of the ferromagnetic material. In the case of the non-magnetic layer described later, the content thereof may be, for example, from 0.01 to 10 parts by mass per 100 parts by mass of non-magnetic powder.

The thickness of the magnetic layer is optimized with respect to the saturation magnetization and the head gap length of the magnetic head used, and the band of the signals to be recorded, and is generally from 0.01 to 0.15 preferably from 0.02 to 0.12 μm, and more preferably from 0.03 to 0.10 μm. The magnetic layer may be formed of at least one layer, and may be a laminated magnetic layer separated into two or more layers having different magnetic characteristics, in some cases.

### Non-Magnetic Layer

A non-magnetic layer containing non-magnetic powder and a binder may be provided between the magnetic layer and the non-magnetic support. The non-magnetic powder used in the non-magnetic layer may be an inorganic substance or an organic substance, and carbon black may also be used therefor. Examples of the inorganic substance include a metal, a metal oxide, a metal carbonate, a metal sulfate, a metal nitride, a metal carbide, and a metal sulfide. The non-magnetic powder is available as a commercially available product and may be produced by a known method. Specific examples thereof include titanium oxide, such as titanium dioxide, cerium oxide, tin oxide, tungsten oxide, ZnO, ZrO₂, SiO₂, Cr₂O₃, α-alumina having an alphanization degree of from 90 to 100%, β-alumina, γ-alumina, α-iron oxide, goethite, corundum, silicon nitride, titanium carbide, magnesium oxide, boron nitride, molybdenum disulfide, copper oxide, MgCO₃, CaCO₃, BaCO₃, SrCO₃, BaSO₄, silicon carbide, and titanium carbide, which may be used solely or as a combination of two or more kinds thereof. Representative examples thereof include α-iron oxide, titanium oxide, and carbon black.

The shape of the non-magnetic powder may be any of an acicular shape, a spherical shape, a polygonal shape, and a planar shape. The crystallite size of the non-magnetic powder is preferably 4 nm or more and 500 nm or less, and more preferably 4 nm or more and 100 nm or less. The crystallite size that is in a range of from 4 to 500 nm is preferred since a good surface roughness may be obtained without difficulty in dispersion. The average particle diameter of the non-magnetic powder is preferably from 5 to 500 nm, and the similar effect may be obtained depending on necessity in such a manner that plural kinds of the non-magnetic powder having different average particle diameters are combined, a single kind of the non-magnetic powder that has a broadened particle diameter distribution is used. The average particle diameter of the non-magnetic powder is particularly preferably from 10 to 200 nm. The particle diameter thereof that is in a range of from 5 to 500 nm is preferred since good dispersibility may be obtained, and a good surface roughness may be provided.

The specific surface area of the non-magnetic powder may be, for example, from 1 to 150 m²/g, preferably from 20 to 120 m²/g, and more preferably from 50 to 100 m²/g. When the specific surface area is in a range of from 1 to 150 m²/g, a good surface roughness may be obtained, and the powder may be dispersed with a suitable amount of the binder. The oil absorption capacity using dibutyl phthalate (DBP) thereof may be, for example, from 5 to 100 mL/100 g, preferably from 10 to 80 mL/100 g, and more preferably from 20 to 60 mL/100 g. The specific gravity thereof may be, for example, from 1 to 12, and preferably from 3 to 6. The tap density thereof may be, for example, from 0.05 to 2 g/mL, and preferably from 0.2 to 1.5 g/mL. When the tap density is in a range of from 0.05 to 2 g/mL, the amount of scattered particles may be small with good handleability, and the powder tends not to be adhered to equipments. The powder pH of the non-magnetic powder is preferably from 2 to 11, and particularly preferably from 6 to 9. When the powder pH is in a range of from 2 to 11, the frictional coefficient may be prevented from being increased under a high temperature and a high humidity or due to the liberation of the fatty acid. The water content of the non-magnetic powder may be, for example, from 0.1 to 5% by mass, preferably from 0.2 to 3% by mass, and more preferably from 0.3 to 1.5% by mass. When the water content is in a range of from 0.1 to 5% by mass, good dispersibility may be obtained, and the viscosity of the coating material after dispersing tends to be stabilized. The ignition loss thereof is preferably 20% by mass or less.

In the case where the non-magnetic powder is inorganic powder, the Mohs hardness thereof is preferably from 4 to 10. When the Mohs hardness is from 4 to 10, the durability may be assured. The stearic acid adsorption amount of the non-magnetic powder is preferably from 1 to 20 μmol/m², and more preferably from 2 to 15 μmol/m². The wetting heat with water at 25° C. of the non-magnetic powder is preferably in a range of from 200 to 600 erg/cm² (from 200 to 600 mJ/m²). A solvent providing a wetting heat within the range may be used. The amount of water molecules on the surface at a temperature of from 100 to 400° C. is suitably from 1 to 10 per 10 nm. The pH of the isoelectric point in water is preferably from 3 to 9. The non-magnetic powder preferably has on the surface thereof Al₂O₃, SiO₂, TiO₂, ZrO₂, SnO₂, Sb₂O₃, or ZnO, through a surface treatment. Among these, Al₂O₃, SiO₂, TiO₂, and ZrO₂ are preferred for the dispersibility, and Al₂O₃, SiO₂, and ZrO₂ are more preferred. These may be used in combination or may be used solely. A surface-treated layer obtained through coprecipitation may be used depending on purposes, and a method of treating with alumina and then treating the surface layer thereof with silica, or the inverse method thereof may be used. The surface-treated layer may be a porous layer depending on purposes, and is generally preferably homogeneous and dense.

For the binder, the lubricant, the dispersant, the additive, the solvent, the dispersing method, and the like of the non-magnetic layer, those of the magnetic layer may be used. In particular, for the amount and the kind of the binder, and the amounts and the kinds of the additive and the dispersant, known techniques relating to a magnetic layer may be used. The non-magnetic layer may contain carbon black and organic powder.

In the non-magnetic layer, carbon black may be mixed along with the non-magnetic powder, by which the surface electric resistance is reduced, the light transmittance is reduced, and the hardness is controlled. For example, furnace black for rubber, thermal black for rubber, carbon black for colorant, acetylene black and the like may be used in the non-magnetic layer.

The specific surface area of the carbon black used in the non-magnetic layer may be, for example, from 100 to 500 m²/g, and preferably from 150 to 400 m²/g, and the DBP absorption capacity thereof may be, for example, from 20 to 400 mL/100 g, and preferably from 30 to 200 mL/100 g. The particle diameter of the carbon black may be, for example, from 5 to 80 nm, preferably from 10 to 50 nm, and more preferably from 10 to 40 nm. The powder pH of the non-magnetic powder is preferably from 2 to 10, the water content thereof is preferably from 0.1 to 10%, and the tap density thereof is preferably from 0.1 to 1 g/mL. The carbon black that has been subjected to a surface treatment with a dispersant or the like may be used. The carbon black that has been grafted with a resin may be used. The carbon black that has been graphitized on a part of the surface thereof may be used. The carbon black may be dispersed with a binder before dispersing in a coating material. The carbon black is preferably used in a range that does not exceed 50% by mass based on the non-magnetic powder and a range that does not exceed 40% based on the total mass of the non-magnetic layer. The carbon black may be used solely or as a combination. For the carbon black that may be used in the non-magnetic layer, reference may be made to “Carbon Black Binran” (Carbon Black Handbook), edited by Carbon Black Association. These may be available as commercial products.

The non-magnetic layer may contain organic powder depending on purposes. Examples of the organic powder include acrylic-styrene resin powder, benzoguanamine resin powder, melamine resin powder, and a phthalocyanine pigment, and polyolefin resin powder, polyester resin powder, polyamide resin powder, polyimide resin powder, and polyethylene fluoride resin powder may also be used. For the production method therefor, the techniques described in JP-A-62-18564 and JP-A-60-255827 may be used.

The thickness of the non-magnetic layer may be, for example, from 0.1 to 3.0 μm, preferably from 0.1 to 2.0 μm, and more preferably from 0.1 to 1.5 μm. The non-magnetic layer may exhibit the effects thereof as far as the layer is substantially non-magnetic. Specifically, the layer preferably does not have a residual magnetic flux density and a coercive force, and it is allowable that the non-magnetic layer may have a residual magnetic flux density in a range of 10 mT or less and a coercive force in a range of 7.96 kA/m (100 Oe) or less. The layer corresponds to the non-magnetic layer herein irrespective of a small amount of a magnetic material contained therein as an impurity or intentionally, when the residual magnetic flux density and the coercive force are suppressed within the ranges.

### Non-Magnetic Support

Examples of the non-magnetic support include known ones, such as polyethylene terephthalate, polyethylene naphthalate, polyamide, polyamideimide, and aromatic polyamide, having been subjected to biaxial stretching. Among these, polyethylene terephthalate, polyethylene naphthalate, and polyamide are preferred. The support may be subjected to corona discharge, a plasma treatment, an easy adhesion treatment, a heat treatment or the like in advance. The surface roughness of the non-magnetic support is preferably from 3 to 10 nm in terms of arithmetic average surface roughness Ra at a cutoff value of 0.25 mm. The thickness of the non-magnetic support is generally preferably from 3 to 10 μm.

### Back Coating Layer

A back coating layer may be provided on the surface of the non-magnetic support that is opposite to the surface having the magnetic layer formed thereon. The back coating layer preferably contains carbon black and inorganic powder. For the binder and the additives for forming the back coating layer, the formulations of the magnetic layer and the non-magnetic layer may be used. The thickness of the back coating layer is preferably 1.0 μm or less, and more preferably from 0.2 to 0.8 μm.

### Production Method of Magnetic Recording Medium

The production method of the magnetic recording medium using the hexagonal ferrite magnetic powder according to the invention in the magnetic layer is not particularly limited, and an example thereof is described below for a coating type magnetic recording medium.

A step of producing a coating liquid for forming the magnetic layer, the non-magnetic layer, or the back coating layer contains generally, at least, a kneading step, a dispersing step, and a mixing step that is provided depending on necessity before or after these steps. The steps each may be divided into two or more stages. All the raw materials, i.e., the ferromagnetic powder (i.e., the hexagonal ferrite magnetic powder according to the invention), the non-magnetic powder, the binder, the carbon black, the abrasive, the antistatic agent, the lubricant, the solvent, and the like, may be added in the initial stage or in the course of any one of the steps. The raw materials each may be divided to and added in two or more steps. For example, polyurethane may be added by dividing into the kneading step, the dispersing step, and the mixing step performed for controlling the viscosity after dispersing. In the kneading step, an apparatus having strong kneading power, such as an open kneader, a continuous kneader, a pressure kneader, and an extruder, is preferably used. For the details of the kneading treatment, reference may be made to JP-A-1-106338 and JP-A-1-79274. Glass beads may be used for dispersing the coating liquid for the magnetic layer, the coating liquid for the non-magnetic layer, or the coating liquid for the back coating layer. The glass beads used are preferably a dispersion medium having a large specific gravity, such as zirconia beads, titania beads, or steel beads. The particle diameter and the packing ratio of the dispersion medium are optimized before use. A known dispersing apparatus may be used.

In the production method of the magnetic recording medium, for example, the coating liquid for the non-magnetic layer is coated on the surface of the running non-magnetic support to form the non-magnetic layer, and then the coating liquid for the magnetic layer is coated thereon to a prescribed thickness to form the magnetic layer. Plural coating liquids for the magnetic layer may be overlaid subsequently or simultaneously, and the coating liquid for the non-magnetic layer and the coating liquid for the magnetic layer may be overlaid subsequently or simultaneously. Examples of the coating machine utilized for coating the coating liquid for the magnetic layer or the coating liquid for the non-magnetic layer include air doctor coater, blade coater, rod coater, extrusion coater, air knife coater, squeeze coater, impregnation coater, reverse roll coater, transfer roll coater, gravure coater, kiss coater, cast coater, spray coater, and spin coater. For these methods, reference may be made, for example, to “Saishin Coating Gijutsu” (Newest Coating Techniques), published by Sogo Gijutsu Center, Co., Ltd. (May 31, Showa-58 (1983)).

For the coated layer of the coating liquid for the magnetic layer, in the case where a magnetic tape is produced, the ferromagnetic powder contained in the coated layer of the coating liquid for the magnetic layer may be subjected to a magnetic field orientation treatment by using a magnet or a solenoid. In the case where a disk is produced, a sufficiently isotropic orientation may be obtained in some cases without orientation using no orientation device, but a known random orientation device is preferably used, such as cobalt magnets disposed obliquely and alternately, and an alternating current magnetic field applied with a solenoid. Furthermore, magnetic characteristics that are isotropic in the circumferential direction may be applied to make a vertical orientation by using a known method, such as a magnetically opposed magnet. In particular, a vertical orientation is preferred for high-density recording. A circumferential orientation may be provided by spin coating.

The drying position of the coated film is preferably controlled by controlling the temperature and the amount of the drying air and the coating speed. The coating speed is preferably from 20 to 1,000 m/min, and the temperature of the drying air is preferably 60° C. or more. Preliminary drying may be performed to an appropriate level before entering the magnet zone.

The coated raw material thus obtained is once wound by a winding roll, then wound off from the winding roll, and then subjected to a calendar treatment. Examples of the calendar treatment used include a supercalendar treatment. The calendar treatment may improve the surface smoothness and diminishes the voids formed through the removal of the solvent on drying to improve the packing ratio of the ferromagnetic powder in the magnetic layer, and thus a magnetic recording medium having high electromagnetic conversion characteristics. The step of performing the calendar treatment is preferably performed while changing the calendar treatment condition corresponding to the surface smoothness of the coated raw material. The calendar roll used may be a heat resistant resin roll, such as epoxy, polyimide, polyamide, or polyamideimide. A metal roll may also be used for the treatment.

For the calendar treatment condition, the temperature of the calendar roll may be, for example, in a range of from 60 to 110° C., preferably in a range of from 70 to 110° C., and particularly preferably in a range of from 80 to 110° C., the pressure may be, for example, in a range of from 100 to 500 kg/cm (from 98 to 490 kN/m), preferably in a range of from 200 to 450 kg/cm (from 196 to 441 kN/m), and particularly preferably in a range of from 300 to 400 kg/cm (from 294 to 392 kN/m). A calendar treatment under the condition may be applied to the surface of the non-magnetic layer.

The resulting magnetic recording medium may be used after cutting into a desired size by using a cutting machine or the like. The cutting machine is not particularly limited, and one having plural pairs of a rotating upper blade (male blade) and a rotating lower blade (female blade) is preferred, in which the slitting speed, the engagement depth, the circumferential speed ratio of the upper blade (male blade) and the lower blade (female blade) (upper blade circumferential speed/lower blade circumferential speed), the continuous use time of the slitting blades, and the like may be appropriately selected.

The magnetic recording medium described hereinabove contains the hexagonal ferrite magnetic particles according to the invention, and thereby achieves excellent electromagnetic conversion characteristics in the field of high-density recording while maintaining the high durability of the magnetic layer.

### EXAMPLE

Hexagonal ferrite magnetic powder was produced with various raw material formulations, and the resulting magnetic powder was subjected to the component analysis, the measurement of the magnetic characteristics, the measurement of the specific surface area, and the calculation of the activation volume Vact. A magnetic tape was produced with the magnetic powder, and evaluated for the electromagnetic conversion efficiency (i.e., the reproduction output power and the SNR) and the durability of the coated film. The methods therefor and the results thereof are shown below.

### Production of Hexagonal Ferrite Magnetic Powder

### Examples 1 to 4

As raw materials, boric acid H₃BO₃ (industrial use), barium carbonate BaCO₃ (industrial use), iron oxide Fe₂O₃ (industrial use), cobalt oxide CoO (reagent with purity of 90%; or higher), titanium oxide TiO₂ (first class reagent), bismuth oxide Bi₂O₃ (industrial use), and neodymium oxide Nd₂O₃ (industrial use) were weighed and mixed with FM Mixer, produced by Mitsui Miike Machinery Co., Ltd., to provide a raw material mixture. The weight amounts in the examples are shown in Table 1. The raw material mixture was placed in a pelletizer, granulated by molding into a spherical shape with water sprayed thereon, and then dried at 270° C. for 14 hours, thereby provide granulated products having a particle diameter of from 1 to 50 mm.

The granulated product was melted with a melting furnace using a platinum crucible. The product was heated to 1,400° C. and retained at that temperature for 60 minutes under agitation to make the raw material substances in a completely molten state, and the molten product (melt) was discharged from a nozzle and quenched by a gas atomization method, thereby providing an amorphous material. The resulting amorphous material was crystallized by heating to and retaining at a prescribed temperature, thereby forming hexagonal ferrite. The heating and retaining temperature is shown as a crystallization treatment temperature in Table 1. The retention time at that temperature was 60 minutes.

The powder obtained by the heating and retaining operation contains residual substances formed mainly of barium borate, in addition to the hexagonal ferrite. The powder was immersed in an acetic acid aqueous solution of from 6 to 10% by mass heated to a temperature of from 30 to 85° C., and retained for from 0.5 to 2 hours under agitation, so as to dissolve the residual substances in the liquid. The powder was subjected to solid-liquid separation by filtration, and then rinsed with pure water. Thereafter, the solid matter thus recovered was agitated with pure water, and then subjected to wet pulverization with a wet pulverizer, Starmill.

An aluminum chloride aqueous solution was added to the slurry containing a solid content obtained after the wet pulverization. The amount of Al added by aluminum chloride was 3.3 parts by mass for Examples 1, 3, and 4 and 8.7 parts by mass for Example 2, in terms of Al(OH)₃ per 100 parts by mass of the solid content. The slurry having the aluminum chloride aqueous solution added thereto was agitated at 40° C. for 10 minutes. A pH of the slurry is in a range of from 3.0 to 4.0. Thereafter, sodium hydroxide was added thereto to regulate the pH to from 8.0 to 9.0, and then the mixture was further agitated at 40° C. for 10 minutes, thereby forming a layer of an aluminum hydroxide material as a reaction product on the surface of the particles of the solid content (i.e., the hexagonal ferrite magnetic particles). Thereafter, the mixture was subjected to solid-liquid separation by filtration, and rinsed with pure water added thereto until the conductivity of the liquid obtained after rinsing (filtrate) was lowered to 10 μS/cm or less. After rinsing with water, the material was dried in the air at 110° C. for 12 hours. Thus, a specimen of magnetic powder containing Bi-containing hexagonal Ba ferrite particles having deposited to the surface thereof the aluminum hydroxide material was provided.

### Comparative Examples 1 to 3

In the comparative examples, the surface treatment for depositing the aluminum hydroxide material to the surface of the hexagonal ferrite particles was not performed. The hexagonal ferrite magnetic powder was produced in the method described below. Comparative Examples 1 and 2 are examples, in which Al is added to the raw material in the initial stage, and Comparative Example 3 is an example having no Al added.

As raw materials, boric acid H₃BO₃ (industrial use), aluminum hydroxide Al(OH)₃ (first class reagent), barium carbonate BaCO₃ (industrial use), iron oxide Fe₂O₃ (industrial use), cobalt oxide CoO (reagent with purity of 90% or higher), titanium oxide TiO₂ (first class reagent), bismuth oxide Bi₂O₃ (industrial use), and neodymium oxide Nd₂O₃ (industrial use) were weighed and mixed with FM Mixer, produced by Mitsui Miike Machinery Co., Ltd., to provide a raw material mixture. The weight amounts in the examples are shown in Table 1. The raw material mixture was placed in a pelletizer, granulated by molding into a spherical shape with water sprayed thereon, and then dried at 270° C. for 14 hours, thereby provide granulated products having a particle diameter of from 1 to 50 mm.

The granulated product was melted with a melting furnace using a platinum crucible. The product was heated to 1,400° C. and retained at that temperature for 60 minutes under agitation to make the raw material substances in a completely molten state, and the molten product (melt) was discharged from a nozzle and quenched by a gas atomization method, thereby providing an amorphous material. The resulting amorphous material was crystallized by heating to and retaining at a prescribed temperature, thereby forming hexagonal ferrite. The heating and retaining temperature is shown as a crystallization treatment temperature in Table 1. The retention time at that temperature was 60 minutes.

The powder obtained by the heating and retaining operation contains residual substances formed mainly of barium borate, in addition to the hexagonal ferrite. The powder was immersed in an acetic acid aqueous solution of from 6 to 10% by mass heated to a temperature of from 60 to 85° C., and retained for from 1 to 2 hours under agitation, so as to dissolve the residual substances in the liquid. The powder was then subjected to solid-liquid separation by filtration, and the solid content was recovered. In this acid cleaning step, it is considered that a part of Ba occupying the Ba sites of the hexagonal ferrite is also eluted. The acid cleaning conditions are shown in Table 1.

The solid matter thus recovered after the acid cleaning was rinsed with water to remove the components including acetic acid and the like attached to the surface of the particles. The material was rinsed with water until the conductivity of the liquid obtained after rinsing (filtrate) was lowered to 10 μS/cm or less. After rinsing with water, the material was dried in the air at 110° C., thereby providing a specimen of hexagonal ferrite magnetic powder.

The following is common to all the examples.

### Component Analysis of Magnetic Powder

The component analysis of the hexagonal ferrite magnetic powder specimen was performed with a high frequency inductively coupled plasma atomic emission spectrometer ICP (720-ES), produced by Agilent Technologies, Inc. The molar ratios of the elements with respect to Fe were calculated from the resulting quantitative values. The molar ratio of X/Fe for one element X (wherein X is Ba, Bi, Al, or the like) can be calculated by the following expression.

X/Fe molar ratio=X content (% by mol)/Fe content (% by mol)

### Measurement of Powder Magnetic Characteristics

The hexagonal ferrite magnetic powder specimen was placed in a plastic container having a diameter of 6 mm, and measured for the coercive force Hc, the saturation magnetization as, the squareness ratio SQ, and the coercivity distribution SFD (SFD value of the powder in a bulk form), by using VSM (VSM-P7-15), produced by Toei Industry Co., Ltd., at an external magnetic field of 795.8 kA/m (10 kOe).

### Measurement of Specific Surface Area

The hexagonal ferrite magnetic powder specimen was measured for the specific surface area Sbet by the BET one-point method by using 4-Sorb US, produced by Yuasa Ionics Co., Ltd.

### Calculation of Activation Volume Vact

By using a pulse magnetic field generator (produced by Toei Industry Co., Ltd.) and a vibration sample magnetometer (produced by Toei Industry Co., Ltd.), the hexagonal magnetic powder was magnetized to saturation, then applied with a magnetic field in the direction opposite to the saturation magnetization (which was referred to as a reverse magnetic field) for 0.76 ms, and then the residual magnetization after removing the magnetic field was measured. The value of the reverse magnetic field was varied, and the value of the reverse magnetic field Hr (0.76 ms) when the residual magnetization became 0 Am²/kg. The value Hr is referred to as a residual coercivity. The value of the reverse magnetic field applied may be appropriately determined depending on the Hr value of the magnetic material. Subsequently, the same procedures were performed except that the application time was changed to 8.4 ms, and the residual coercivity Hr (8.4 ms) when the residual magnetization became 0 Am²/kg was obtained. The same procedures were further performed by changing the application time to 17 s, and the residual coercivity Hr (17 s) when the residual magnetization became 0 Am²/kg was obtained. By using the values of Hr (0.76 ms), Hr (8.4 ms), and Hr (17 s), values H0 and KuV/kT were calculated by the following expression (1), and the activation value Vact was calculated by substituting the values into the following expression (2).

Hr(t)=H0[1−{(kT/KuV)ln (f0t/ln 2)}^{0.77} (1)

wherein k represents the Boltzmann constant; T represent the absolute temperature; Ku represents the crystalline magnetic anisotropy constant; V represents the activation volume; Hr(t) represents the residual coercivity (Oe) at the time t; H0 represents the residual coercivity (Oe) at 10⁻⁹ sec; f0 represents the spin precession frequency (s⁻¹); and t represents the retention time (s) of the reverse magnetic field, in which the value f0 herein is 10-9 (s⁻¹).

Vact (nm³)=1.505×10⁵×KuV/kT/H0 (2)

### Production of Magnetic Recording Medium (Magnetic Tape)

In the following description, all parts and percentages are parts by mass and percentages by mass, respectively, unless otherwise indicated.

Formulation of Coating Liquid for Magnetic Layer
Magnetic Liquid

| | | |
|---|---|---|
| Hexagonal barium ferrite magnetic particles | 100.0 | parts |
| Oleic acid | 2.0 | parts |
| Vinyl chloride copolymer | 10.0 | parts |
| (MR-104, produced by Zeon Corporation) | | |
| SO₃Na Group-containing polyurethane resin | 4.0 | parts |
| (weight average molecular weight: 70,000, SO₃Na group: | | |
| 0.07 meq/g) | | |
| Amine polymer | 6.0 | parts |
| (Disperbyk-102, produced by BYK-Chemie Japan K.K.) | | |
| Methyl ethyl ketone | 150.0 | parts |
| Cyclohexanone | 150.0 | parts |

Abrasive Liquid

| | | |
|---|---|---|
| α-Alumina | 6.0 | parts |
| (specific surface area: 19 m²/g, sphericity: 1.4) | | |
| SO₃Na Group-containing polyurethane resin | 0.6 | part |
| (weight average molecular weight: 70,000, SO₃Na group: | | |
| 0.1 meq/g) | | |
| 2,3-Dihydroxynaphthalene | 0.6 | part |
| Cyclohexanone | 23.0 | parts |

Non-magnetic Filler Liquid

| | | |
|---|---|---|
| Colloidal silica | 2.0 | parts |
| (average particle size: 120 nm, variation coefficient: 7%, | | |
| sphericity: 1.03) | | |
| Methyl ethyl ketone | 8.0 | parts |

Lubricant and Curing Agent Liquid

| | | |
|---|---|---|
| Stearic acid | 3.0 | parts |
| Stearic acid amide | 0.3 | part |
| Butyl stearate | 6.0 | parts |
| Methyl ethyl ketone | 110.0 | parts |
| Cyclohexanone | 110.0 | parts |
| Polyisocyanate | 3 | parts |
| (Coronate L, a trade name, produced by Nippon | | |
| Polyurethane Industry Co., Ltd.) | | |

Formulation of Coating Liquid for Non-magnetic Layer

| | | |
|---|---|---|
| Non-magnetic powder, α-iron oxide | 100 | parts |
| (average long axis diameter: 10 nm, average acicular ratio: | | |
| 1.9, BET specific surface area: 75 m²/g) | | |
| Carbon black | 25 | parts |
| (average particle diameter: 20 nm) | | |
| SO₃Na Group-containing polyurethane resin | 18 | parts |
| (weight average molecular weight: 70,000, SO₃Na group: | | |
| 0.2 meq/g) | | |
| Stearic acid | 1 | part |
| Cyclohexanone | 300 | parts |
| Methyl ethyl ketone | 300 | parts |

Formulation of Coating Liquid for Back Coating Layer

| | | |
|---|---|---|
| Non-magnetic powder, α-iron oxide | 80 | parts |
| (average long axis diameter: 0.15 μm, average acicular | | |
| ratio: 7, BET specific surface area: 52 m²/g) | | |
| Carbon black | 20 | parts |
| (average particle diameter: 20 nm) | | |
| Vinyl chloride copolymer | 13 | parts |
| Sulfonate salt group-containing polyurethane resin | 6 | parts |
| Phenyl sulfonate | 3 | parts |
| Cyclohexanone | 155 | parts |
| Methyl ethyl ketone | 155 | parts |
| Stearic acid | 3 | parts |
| Butyl stearate | 3 | parts |
| Polyisocyanate | 5 | parts |
| Cyclohexanone | 200 | parts |

### Production of Magnetic Tape

The coating liquid for the magnetic layer was produced in such a manner that the substances according to the formulation of the coating liquid for the magnetic layer were dispersed for 24 hours by using zirconia beads having a diameter of 0.5 mm with a batch type vertical sand mill (beads dispersion), and then filtered with a filter having an average pore diameter of 0.5 μm.

The coating liquid for the non-magnetic layer was produced in such a manner that the substances according to the formulation of the coating liquid for the non-magnetic layer were dispersed for 24 hours by using zirconia beads having a diameter of 0.1 mm with a batch type vertical sand mill (beads dispersion), and then filtered with a filter having an average pore diameter of 0.5 μm.

The coating liquid for the back coating layer was produced in such a manner that the substances according to the formulation of the coating liquid for the back coating layer except for the lubricants (stearic acid and butyl stearate), the polyisocyanate, and 200 parts of cyclohexanone were kneaded and diluted with an open type kneader and then subjected to a dispersion treatment by using zirconia beads having a diameter of 1 mm with a horizontal bead mill disperser at a bead packing ratio of 80% and a circumferential speed of the rotor end of 10 m/sec for 12 passes with a retention time of 2 minutes per one pass, and the remaining substances were added to the resulting liquid, followed by agitating with a dissolver, to provide a dispersion liquid, which was filtered with a filter having an average pore diameter of 1 μm.

The coating liquid for the non-magnetic layer prepared above was coated on a surface of a polyethylene naphthalate support having a thickness of 5 μm (Young's modulus in width direction: 8 GPa, Young's modulus in longitudinal direction: 6 GPa) to a dry thickness of 100 nm and dried, and thereon the coating liquid for the magnetic layer prepared above was coated to a thickness of 70 nm. While the coating liquid for the magnetic layer was undried, a vertical orientation treatment was performed by applying a magnetic field having an intensity of 0.3 T thereto in the direction perpendicular to the coated surface, followed by drying. Thereafter, the coating liquid for the back coating layer prepared above was coated on the opposite surface of the support to a dry thickness of 0.4 μm and dried. The resulting tape was subjected to a surface smoothening treatment with a calendar formed only of metal rollers at a speed of 100 m/min, a linear pressure of 300 kg/cm, and a temperature of 100° C., and then subjected to a heat treatment in a dry environment at 70° C. for 36 hours. After the heat treatment, the tape was slit into a 2-inch width to provide a magnetic tape.

### Measurement of Electromagnetic Conversion Characteristics

The magnetic tape produced above was mounted on a loop tester having a recording head (MIG, gap: 0.15 μm, 1.8 T) and a reproducing GMR head (reproducing track width: 1 μm) under an environment of 23° C.±1° C., and a signal with a linear recording density of 200 kfci was recorded thereon, and then the output power and the SNR were measured. Hexagonal ferrite magnetic powder that is capable of achieving noise characteristics providing SNR of 1.0 dB or more is evaluated as having a performance that is capable of satisfying the upcoming severe demand associated with the increased recording density.

### Evaluation of Durability of Coated Film

A magnetic recording and reproducing head having been detached from LTO G5 (Linear Tape-Open Generation 5), a trade name, produced by IBM Corporation, was attached to a tape running system, and the magnetic tape having a tape length of 20 m was subjected to 3,000 cycles of the tape running operation, in which the tape was wound off from a delivery roll, made to run thereon at 4.0 m/s under application of a tension of 0.6 N, and then wound by a winding roll, under an environment of a temperature of 40° C. and a relative humidity of 80% RH. The entire surface of the head after running the tape was observed with a microscope at a magnification of 100, and the contaminated area (the area of the portion having a deposit attached thereto) was obtained through image processing with an image processing software (Win Roof (produced by Mitani Corporation)). The ratio of the contaminated area with respect to the head surface (contaminated area ratio) as an index of the head surface contamination was evaluated by the following standard. A specimen with a grade 4 or better is determined as having good running durability.

Grade 5: contamination area ratio of 0%
Grade 4: contamination area ratio of more than 0% and less than 5%
Grade 3: contamination area ratio of 5% or more and less than 10%
Grade 2: contamination area ratio of 10% or more and less than 30%
Grade 1: contamination area ratio of 30% or more

The results are shown in Table 1.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Raw material | H₃BO₃ | 818.2 | 818.2 | 832.2 | 832.2 | 638.5 | 693.4 | 701.2 |
| formulation | Al(OH)₃ | 0.0 | 0.0 | 0.0 | 0.0 | 51.9 | 51.4 | 0.0 |
| (g) | BaCO₃ | 1,580.4 | 1,580.4 | 1,598.7 | 1,598.7 | 1,312.1 | 1,268.3 | 1,283.5 |
| | Fe₂O₃ | 927.6 | 927.6 | 902.6 | 902.6 | 770.1 | 754.9 | 766.9 |
| | CoO | 8.7 | 8.7 | 8.5 | 8.5 | 7.2 | 14.2 | 14.4 |
| | TiO₂ | 18.6 | 18.6 | 18.1 | 18.1 | 15.4 | 15.1 | 15.3 |
| | Bi₂O₃ | 107.2 | 107.2 | 104.3 | 104.3 | 89.0 | 88.1 | 89.5 |
| | Nd₂O₃ | 139.4 | 139.4 | 135.6 | 135.6 | 115.7 | 114.6 | 129.3 |
| Crystallization temperature (° C.) | | 680 | 645 | 640 | 670 | 658 | 612 | 615 |
| Acid cleaning | Temperature (° C.) | 60 | 60 | 60 | 60 | 85 | 85 | 60 |
| condition | Processing time | 1 | 1 | 1 | 1 | 2 | 2 | 1 |
| | (h) | | | | | | | |
| | Acetic acid | 10.0 | 10.0 | 10.0 | 10.0 | 6.0 | 6.0 | 10.0 |
| | concentration | | | | | | | |
| | (% by mass) | | | | | | | |
| Magnetic powder | Ba/Fe | 0.093 | 0.086 | 0.086 | 0.096 | 0.087 | 0.077 | 0.087 |
| molar ratio | Al/Fe | 0.044 | 0.123 | 0.045 | 0.045 | 0.051 | 0.035 | 0.000 |
| | Co/Fe | 0.009 | 0.009 | 0.009 | 0.009 | 0.009 | 0.018 | 0.018 |
| | Ti/Fe | 0.018 | 0.020 | 0.020 | 0.021 | 0.020 | 0.020 | 0.020 |
| | Bi/Fe | 0.032 | 0.034 | 0.034 | 0.034 | 0.040 | 0.039 | 0.035 |
| | Nd/Fe | 0.005 | 0.005 | 0.006 | 0.005 | 0.005 | 0.008 | 0.006 |
| Attachment form of Al | | aluminum | aluminum | aluminum | aluminum | aluminum | aluminum | — |
| | | hydroxide | hydroxide | hydroxide | hydroxide | oxide | oxide | |
| | | material | material | material | material | | | |
| Characteristics | Hc (kA/m) | 251 | 213 | 214 | 247 | 231 | 187 | 199 |
| of magnetic | σs (Am²/kg) | 43.3 | 40.6 | 41.9 | 43.0 | 41.0 | 42.0 | 44.7 |
| powder | SQ | 0.55 | 0.53 | 0.53 | 0.55 | 0.54 | 0.52 | 0.52 |
| | SFD | 0.48 | 0.55 | 0.51 | 0.47 | 0.52 | 0.70 | 0.58 |
| | Sbet (m²/g) | 69 | 96 | 92 | 72 | 88 | 91 | 94 |
| | Vact (nm³) | 1,730 | 1,580 | 1,490 | 1,670 | 1,570 | 1,630 | 1,660 |
| Characteristics | SNR (dB) | +1.5 | +1.1 | +1.6 | +1.9 | +1.3 | +0.4 | +1.2 |
| of medium | Durability of | 4 | 5 | 4 | 4 | 2 | 1 | 1 |
| | coated film | | | | | | | |
| | (grade) | | | | | | | |

It was understood from Table 1 that the hexagonal ferrite magnetic powder according to the invention (Examples) was capable of exhibiting high SNR stably in a magnetic recording medium, and exhibited a considerably high performance for the durability of the coated film of the magnetic layer. In Comparative Examples 1 and 2, on the other hand, since Al was added as the initial raw material but was not deposited as the aluminum hydroxide material, Al was formed into aluminum oxide (Al₂O₃) in the process of forming the glassy material, and in the process of cooling the glassy material to deposit ferrite, the surface of the ferrite deposited particles was coated with aluminum oxide. Consequently, the durability of the coated film was deteriorated. In Comparative Example 2, the SNR was largely deteriorated since the Ba/Fe molar ratio of the hexagonal ferrite magnetic powder was as low as 0.077. In Comparative Example 3, the durability of the coated film was deteriorated due to the use of the hexagonal ferrite magnetic powder containing no Al.

1. Hexagonal ferrite magnetic powder for a magnetic recording medium, comprising magnetic powder containing hexagonal ferrite particles having coated on a surface thereof an aluminum hydroxide material, having a Ba/Fe molar ratio of 0.080 or more, a Bi/Fe molar ratio of 0.025 or more, and an Al/Fe molar ratio of from 0.030 to 0.200.

2. The hexagonal ferrite magnetic powder for a magnetic recording medium according to claim 1, wherein the hexagonal ferrite magnetic powder has an activation volume Vact of from 1,300 to 2,000 nm³.

3. The hexagonal ferrite magnetic powder for a magnetic recording medium according to claim 1, wherein the hexagonal ferrite magnetic powder has a coercive force Hc of from 159 to 287 kA/m and a coercivity distribution SFD of from 0.3 to 1.0.

4. The hexagonal ferrite magnetic powder for a magnetic recording medium according to claim 1, wherein the hexagonal ferrite magnetic powder contains one kind or two or more kinds of an element selected from a divalent transition metal and a tetravalent transition metal, as an element that replaces Fe.

5. A method for producing the hexagonal ferrite magnetic powder for a magnetic recording medium according to claim 1, comprising:
a step of depositing an aluminum hydroxide material to a surface of hexagonal ferrite particles in an aqueous medium;
a step of rinsing the hexagonal ferrite particles having the aluminum hydroxide material deposited thereto, with water; and
a step of drying the hexagonal ferrite particles after being rinsed with water, at a temperature of 120° C. or less.

6. A method for producing the hexagonal ferrite magnetic powder for a magnetic recording medium according to claim 1, comprising:
a step of adding an alkali to an aluminum salt aqueous solution having hexagonal ferrite particles dispersed therein having pH of from 2.0 to 5.0, so as to control the pH to from 7.0 to 10.0, thereby depositing an aluminum hydroxide material to a surface of the hexagonal ferrite particles;
a step of rinsing the hexagonal ferrite particles having the aluminum hydroxide material deposited thereto, with water; and
a step of drying the hexagonal ferrite particles after being rinsed with water, at a temperature of 120° C. or less.
